(19) United States
(12) Patent Application Publication
(10) Pub. No.: US 2006/0116889 A1
(43) Pub. Date: Jun. 1, 2006

(54) Fax order acceptance/order settling system

(76) Inventors: Sinobu Hasebe, Tokyo (JP); Miwa Nishio, Tokyo (JP); Mitsuhiko Kuroda, Shiga (JP)

Correspondence Address: RABIN & Berdo, PC, 1101 14TH STREET, NW, SUITE 500, WASHINGTON, DC, 20005, US

(21) Appl. No.: 10/532,665

(22) PCT Filed: Oct. 29, 2003
(86) PCT No.: PCT/JP03/13862

§ 371 Date: Apr. 27, 2005

(30) Foreign Application Priority Data
Oct. 30, 2002 (JP) 2002-316282

(51) Int. Cl. G06Q 99/00

(52) U.S. Cl. 705/1

(57) ABSTRACT

It is an object of the present invention to provide a FAX order receiving and placing settlement system, which is cheap and simple, and has high security, wherein, when order acceptance and placement for purchase goods are performed by using facsimile, settlement of account is performed automatically, thereby eliminating the need for the supplier to prepare a bill, send it and confirm the payment, and for the buyer to confirm the bill and to go through the procedure to transfer the amount of money for the purchase goods to the bank account of the supplier. A FAX order receiving and placing settlement service center transmits order information to a supplier's fax machine, based on order information received from a buyer's fax machine, requests a settlement organization to perform settlement processing of the account for the purchase goods or services, and returns a report including the settlement processing result to the buyer's fax machine and the supplier's fax machine.

### TECHNICAL FIELD

The present invention relates to a FAX order receiving and placing settlement system.

### BACKGROUND ART

Conventionally, when a buyer such as a retail shop buys purchase goods such as goods and raw materials from a supplier such as a wholesaler, the buyer normally sends the order contents including items and quantities of the purchase goods by facsimile (FAX). In this case, the buyer places an order by allowing his/her fax machine to read an order sheet on which the order contents are written, and transmit the order contents. The supplier accepts the order by receiving the order sheet by his/her fax machine and reading the order contents printed on a sheet of paper.

Such an order receiving and placing system for purchase goods using facsimile can convey the order contents more accurately, as compared with an order receiving and placing system for purchase goods using phone, and even when the supplier on the reception side is not in the office, placement of order can be performed. Moreover, the buyer can store the order sheet on which the order contents are printed as an order record, and the supplier can store the order sheet on which the order contents are printed by his/her fax machine as an order acceptance record. Furthermore, the order receiving and placing system for purchase goods using facsimile does not require plant and equipment investment such as a computer, and special knowledge such as computer operation, and a security problem does not occur as in the communication using the Internet. Hence, the order receiving and placing system for purchase goods using facsimile becomes very popular.

In the conventional order receiving and placing system for purchase goods using facsimile, however, it is necessary for the buyer and the supplier to settle an account for the purchase goods in the conventional manner. Therefore, it is necessary for the supplier to prepare a bill for the purchase goods, and send it to the buyer, or go to the buyer to collect money. Hence, it is not only troublesome but also time-consuming, and increasing the cost such as communication expenses. Further, since the buyer has to go to a branch of a banking facility such as a bank or a shinkin bank to go through the procedure for transferring the amount of money for the purchase goods to the bank account of the supplier, it is not only troublesome but also time-consuming, and increasing the cost such as transportation expenses.

Moreover, since the supplier has to sort out and arrange the order contents printed on sheets of paper stored as order acceptance record for each of the predetermined terms, in order to prepare bills, it is not only troublesome but also time-consuming. The buyer also has to sort out and arrange the order contents printed on sheets of paper stored as order record for each of the predetermined terms, for confirming the contents of the bills, and hence it is not only troublesome but also time-consuming. Furthermore, the supplier needs to confirm whether or not the account has been settled, and hence it is not only troublesome but also time-consuming.

### SUMMARY OF THE INVENTION

It is an object of the present invention to provide a FAX order receiving and placing settlement system, which is cheap and simple, has high security, and can solve the problems in the conventional order receiving and placing system, wherein, when order acceptance and placement for purchase goods are performed by using facsimile, settlement of account is performed automatically, thereby eliminating the need for the supplier to prepare a bill, send it and confirm the payment, and for the buyer to confirm the bill and to go through the procedure to transfer the amount of money for the purchase goods to the bank account of the supplier.

According to the present invention, there is provided a FAX order receiving and placing settlement system comprising:

(a) a fax machine of a buyer who places an order for purchase goods or services;

(b) a fax machine of a supplier who receives the order for purchase goods or services;

(c) a settlement organization which performs settlement processing of the account for the purchase goods or services; and

(d) a FAX order receiving and placing settlement service center connected to the buyer's fax machine, the supplier's fax machine and the settlement organization so as to be able to communicate with one another,

(e) wherein the FAX order receiving and placing settlement service center transmits order information to the supplier's fax machine based on order information received from the buyer's fax machine, requests the settlement organization to perform settlement processing of the account for the purchase goods or services, and returns a report including the result of the settlement processing to the buyer's fax machine and the supplier's fax machine.

In the FAX order receiving and placing settlement system, the buyer's fax machine or the supplier's fax machine conforms to the fixed phone Internet service.

Moreover, in the FAX order receiving and placing settlement system, the FAX order receiving and placing settlement service center comprises databases for storing order reception information, the order placement information, and settlement processing results, and transmits a report including the settlement processing results within a predetermined term, to the buyer's fax machine or the supplier's fax machine.

Moreover, in the FAX order receiving and placing settlement system, the FAX order receiving and placing settlement service center comprises a buyer and supplier registration management AP section, for registering in advance and managing information of a buyer and a supplier who has dealings with the buyer.

Moreover, in the FAX order receiving and placing settlement system, the FAX order receiving and placing settlement service center comprises a FAX reception processing section and a FAX transmission processing section, for analyzing fax data in a received order sheet by using an OCR function, and returning the fax data to the buyer's fax machine for confirmation.

Moreover, in the FAX order receiving and placing settlement system, the FAX order receiving and placing settlement service center comprises a remittance management section, and when the buyer transmits an instruction relating to cancellation or change of order placement from the fax machine or by phone, the FAX order receiving and placing settlement service center cancels or changes the transaction.

Moreover, in the FAX order receiving and placing settlement system, the FAX order receiving and placing settlement service center comprises a remittance management section, and when the supplier transmits an instruction relating to cancellation or change of order placement from the fax machine or by phone, the FAX order receiving and placing settlement service center cancels or changes the transaction.

Moreover, in the FAX order receiving and placing settlement system, in a case where the buyer's fax machine conforms to the fixed phone Internet service, when the buyer transmits fax data on an authority sheet to the FAX order receiving and placing settlement service center, the FAX order receiving and placing settlement service center obtains an e-mail address of the buyer based on the received phone number, and performs authentication of the buyer by transmitting an e-mail to the buyer.

Moreover, in the FAX order receiving and placing settlement system, in a case where the buyer's fax machine conforms to the fixed phone Internet service, and when the buyer transmits fax data on an authority sheet to the FAX order receiving and placing settlement service center, the FAX order receiving and placing settlement service center obtains an e-mail address of the buyer based on the received phone number, and transmits an e-mail describing the URL of a Web page, in which an orderer, an ordered products, an ordered amount and the like can be input, to the buyer, and the buyer places an order by inputting the data into the Web page.

According to present invention, there is also provided a FAX order receiving and placing settlement service center comprising:

(a) a reception processing section which receives order information for purchase goods or services from a buyer's fax machine, analyzes and stores the information in database;

(b) a transmission processing section which transmits the order information for purchase goods or services to a supplier's fax machine; and

(c) a settlement organization communication interface section communicating with a settlement organization which performs settlement processing of the account for the purchase goods or services, (d) wherein the FAX order receiving and placing settlement service center transmits the order information to the supplier's fax machine based on the order information, requests the settlement organization to perform settlement processing of the account for the purchase goods or services, and returns a report including the settlement processing result to the buyer's fax machine and the supplier's fax machine.

Moreover, the FAX order receiving and placing settlement service center may further comprise a remittance management section which manages the movement of funds based on the settlement processing, and remittance management database for storing the history of the movement of funds.

Moreover, the FAX order receiving and placing settlement service center may transmit a report including the result of the settlement processing within a predetermined term to the buyer's fax machine or the supplier's fax machine.

According to the present invention, there is also provided a FAX order receiving and placing settlement service program which causes a computer to function as:

(a) in order to receive or place an order for purchase goods or services and settle the account, (b) a reception processing section which receives order information for purchase goods or services from a buyer's fax machine;

(c) a transmission processing section which transmits the order information for purchase goods or services to a supplier's fax machine; and

(d) a settlement organization communication interface section communicating with a settlement organization which performs settlement processing of the account for the purchase goods or services, in order to receive or place an order for purchase goods or services and settle the account,

(e) so that the order information is transmitted to the supplier's fax machine based on the order information, settlement processing of the account for the purchase goods or services is requested to the settlement organization, and a report including the settlement processing result is returned to the buyer's fax machine and the supplier's fax machine.

According to the present invention, there is also provided a FAX order receiving and placing settlement method, comprising steps of:

(a) when order information is received from a fax machine of a buyer who places an order for purchase goods or services,

(b) the order information is transmitted to a fax machine of a supplier who receives the order for purchase goods or services,

(c) settlement processing of the account for the purchase goods or services is requested to a settlement organization, and

(d) a report including the settlement processing result is returned to the buyer's fax machine or the supplier's fax machine.

### BRIEF DESCRIPTION OF THE DRAWINGS

FIG. 1 is a conceptual diagram of a FAX order receiving and placing settlement system in a first embodiment of the present invention.

FIG. 2 is a functional block diagram of a FAX order receiving and placing settlement service center in the first embodiment of the present invention.

FIG. 3 illustrates the operation of the FAX order receiving and placing settlement system in the first embodiment of the present invention.

FIG. 4 is a sequence diagram illustrating the operation of the FAX order receiving and placing settlement system in the first embodiment of the present invention.

FIG. 5 is a conceptual diagram of a FAX order receiving and placing settlement system in a second embodiment of the present invention.

FIG. 6 is a functional block diagram of a FAX order receiving and placing settlement service center in the second embodiment of the present invention.

FIG. 7 illustrates the operation of the FAX order receiving and placing settlement system in the second embodiment of the present invention.

FIG. 8 is a sequence diagram illustrating the operation of the FAX order receiving and placing settlement system in the second embodiment of the present invention.

### BEST MODE FOR CARRYING OUT THE INVENTION

The embodiments of the present invention will be described in detail, with reference to the drawings.

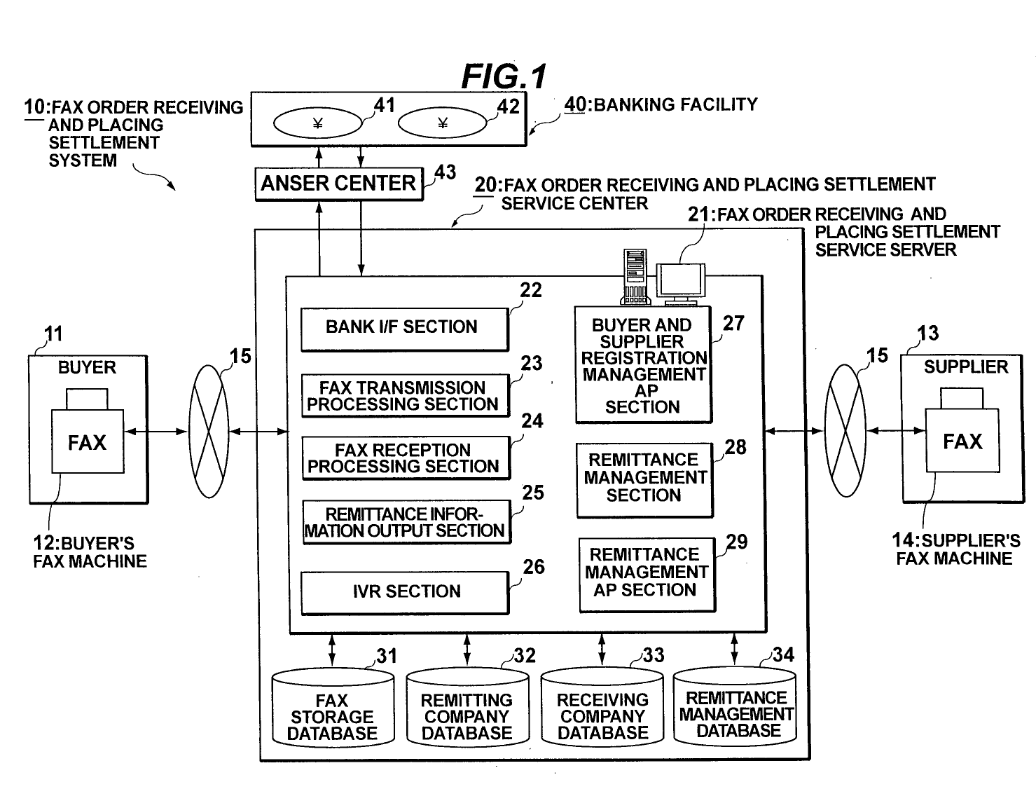

FIG. 1 is a conceptual diagram of a FAX order receiving and placing settlement system in a first embodiment of the present invention.

In the drawings, reference numeral 10 denotes a FAX order receiving and placing settlement system, 11 denotes a buyer who places an order for purchase goods, and 13 denotes a supplier who receives the order for purchase goods. Here, the buyer 11 is a person who buys purchase goods from the supplier 13, and for example, a shop for selling various goods, or may be eating houses such as restaurants or bars, shops for providing services such as barbershops, offices, or individual persons. The purchase goods are goods to be sold at the shop, or may be commodities required for providing services, for example, food in the eating houses, detergents, cosmetics and scissors in barbershops, or stationeries and office machinery consumed or used in the offices or individual houses. Moreover, the purchase goods may be services (labors) such as transportation, cleaning or consigned deskwork. Further, the supplier 13 is a person who sells the purchase goods to the buyer 11, and for example, wholesalers or shops such as retail shops, or may be a person who manufactures goods, such as a factory, or a person who provides various services.

The buyer 11 and the supplier 13 respectively have a buyer's fax machine 12 and a supplier's fax machine 14, as the own fax machine. The buyer's fax machine 12 and the supplier's fax machine 14 may be of any types, and for example, may be a home machine of a dual purpose type used as a normal telephone set and a fax machine, or may be a complex machine in which the fax machine is integrated with a copying machine and a printer. When an interactive voice request (IVR) function is used, the buyer's fax machine 12 and the supplier's fax machine 14 are apparatus having a phone function. The buyer's fax machine 12 and the supplier's fax machine 14 are connected to a public network 15, comprising a wired or a wireless telephone network.

Reference numeral 40 denotes a banking facility as a settlement organization for performing settlement of accounts for the purchase goods, and for example, may be a bank, a shinkin bank or a credit company. In the banking facility 40, a buyer's account 41 as an account of the buyer 11 and a supplier's account 42 as an account of the supplier 12 are opened, and there is provided an accounting computer system (not shown) having a communication interface and the like. Requests for financing processing such as money transfer can be transmitted to the accounting computer system, via an ANSER (R) center 43 used for automatic answer network system for electrical request (ANSER) (R) for providing services such as fund transfer in the banking facility 40. In this case, the ANSER (R) center 43 is a kind of computer system and functions as a part of the settlement organization.

Reference numeral 20 denotes a FAX order receiving and placing settlement service center, having a FAX order receiving and placing settlement service server 21 as a computer, having arithmetic means such as a CPU or an MPU, memory means such as a semiconductor memory or a magnetic disk, and a communication interface. The FAX order receiving and placing settlement service center 20 provides a FAX order receiving and placing settlement service, in which when the buyer 11 and the supplier 13 respectively place and receive order for purchase goods by using the buyer's fax machine 12 and supplier's fax machine 14, settlement of account is automatically performed. The FAX order receiving and placing settlement service server 21 may be a single apparatus, or apparatus such as a dispersed server, in which a plurality of servers are organically connected. The person who operates the FAX order receiving and placing settlement service center 20 may be anyone, such as an individual person, a corporate body, an undertaking for profit, or a public utility corporation, and may be the same person who operates the banking facility 40.

The person who operates the FAX order receiving and placing settlement service center 20 makes an agreement relating to the FAX order receiving and placing settlement service with the buyer 11 and the supplier 13 in advance, and provides the FAX order receiving and placing settlement service to the buyer 11 and the supplier 13. The person who operates the FAX order receiving and placing settlement service center 20 makes an agreement relating to the settlement of account performed via the banking facility 40 and the ANSER (R) center 43, beforehand according to need, so that the FAX order receiving and placing settlement service server 21 can request the settlement of account for the purchase goods, that is, can transmit a request for financial processing such as money transfer. In this case, since having obtained permission of the buyer 11 and the supplier 13 beforehand, the FAX order receiving and placing settlement service center 20 can transmit a request for money transfer from the buyer's account 41 to the supplier's account 42 to the accounting computer system in the banking facility 40, via the ANSER (R) center 43.

From the viewpoint of function, the FAX order receiving and placing settlement service server 21 comprises a bank interface (I/F) section 22 as a communication interface section in the settlement organization, a FAX transmission processing section 23 as a transmission processing section, a FAX reception processing section 24 as a reception processing section, a remittance information output section 25, an IVR section 26, a buyer and supplier registration management AP (Application Program) section 27, a remittance management section 28, and a remittance management AP section 29. The FAX order receiving and placing settlement service server 21 is connected to a FAX storage database 31, a remitting company database 32, a receiving company database 33 and a remittance management database 34, which are included in the FAX order receiving and placing settlement service center 20. The FAX storage database 31, the remitting company database 32, the receiving company database 33 and the remittance management database 34 may be independent of the FAX order receiving and placing settlement service server 21, or may be arranged in the FAX order receiving and placing settlement service server 21.

The bank I/F section 22 is an interface for transmitting a transfer request to the accounting computer system in the banking facility 40 via the ANSER (R) center 43, and converts a format for the internal system of the FAX order receiving and placing settlement service server 21 into a format for an external system such as the ANSER (R) center 43. The FAX transmission processing section 23 prepares a report for the buyer 11, an order sheet to the supplier 13 and the like, and transmits the report and the order to the buyer's fax machine 12 and the supplier's fax machine 14, respectively, by fax. Moreover, the FAX reception processing section 24 receives an order sheet as order information transmitted from the buyer's fax machine 12 by fax, analyzes and stores as data the contents in the order sheet.

The remittance information output section 25 transmits the order sheet with respect to the supplier 13 to the supplier's fax machine 14, and then prepares a report, as a report including the order contents and the settlement processing result for the ordered purchase goods, for each order receiving and placing processing and for each of the predetermined terms, and transmits the report by fax to the buyer's fax machine 12 and the supplier's fax machine 14. The predetermined term is a term determined for accounting and settlement of account, for example, one month, three months or six months, and the remittance information output section 25 prepares the report at the end of each term, and transmits the report. The IVR section 26 automatically responds by speech to inquiries by phone from the buyer 11 and the supplier 13 relating to change or cancellation of a transaction.

The buyer and supplier registration management AP section 27 registers and manages the information of the buyer 11 and the supplier 13 who has dealings with the buyer 11. The remittance management section 28 manages all histories of movement of funds by financial processing such as money transfer. The remittance management AP section 29 is operated by the person who operates or manages the FAX order receiving and placing settlement service center 20 to cancel or change the financial processing such as money transfer. Moreover, the history of movement of funds can be searched or referred to by using the remittance management AP section 29.

The FAX storage database 31 stores fax data (image data) in the order sheet and the order contents as order information. Here, the order contents include the ordered data, the item and the number of the ordered purchase goods, the amount and the like, which are obtained by the FAX reception processing section 24 by analyzing and extracting the contents in the order sheet. The remitting company database 32 stores the information of the buyer 11, such as a phone number of the buyer's fax machine 12, the account number of the buyer's account 41 opened in the banking facility 40, the password and the like. The receiving company database 33 stores the information of the supplier 13 registered beforehand as a supplier from whom the respective buyers 11 buy purchase goods, that is, a phone number of the supplier's fax machine 14 and the account number of the supplier's account 42 opened in the banking facility 40. The remittance management database 34 stores all histories of movement of funds by the financial processing such as money transfer.

The relationship between the respective functional sections in the FAX order receiving and placing settlement service center 20 will be described below.

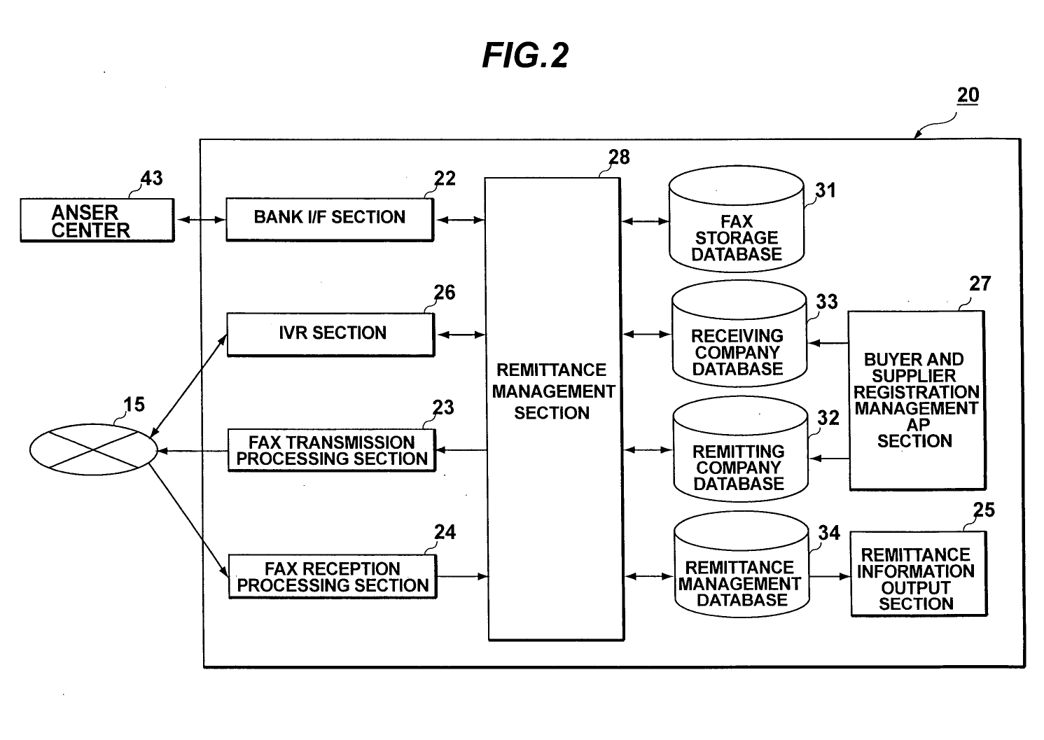

FIG. 2 is a functional block diagram of the FAX order receiving and placing settlement service center in the first embodiment of the present invention.

As shown in FIG. 2, in the FAX order receiving and placing settlement service center 20 in this embodiment, the remittance management section 28 performs the principal function, and transmits/receives information directly with all functional sections excluding the remittance information output section 25 and the buyer and supplier registration management AP section 27. The bank I/F section 22 transmits/receives information relating to the financial transactions such as money transfer with the ANSER (R) center 43, and transmits/receives the information with the remittance management section 28. The IVR section 26 transmits/receives voice signals to/from telephone sets of the buyer 11 and the supplier 13 via the public network 15, and transmits/receives various information to/from the remittance management section 28. The FAX transmission processing section 23 receives data from the remittance management section 28, to prepare reports for the buyer 11 and the supplier 13 and an order sheet with respect to the supplier 13, and transmits the prepared reports and order sheet to the buyer's fax machine 12 and the supplier's fax machine 14 via the public network 15. The FAX reception processing section 24 receives the order sheet from the buyer's fax machine 12 via the public network 15, and transmits data obtained by analyzing the contents in the order sheet to the remittance management section 28.

The remittance management section 28 accesses the FAX storage database 31, the remitting company database 32, the receiving company database 33 and the remittance management database 34, to obtain and store necessary information. The remittance information output section 25 accesses the remittance management database 34 to obtain the history of movement of funds by the financial processing such as money transfer. Moreover, the buyer and supplier registration management AP section 27 accesses the remitting company database 32 to store and register the information of the buyer 11, and accesses the receiving company database 33 to store and register the information of the supplier 13 who has dealings with the buyer 11.

The operation of the FAX order receiving and placing settlement system 10 having the above configuration will be described below.

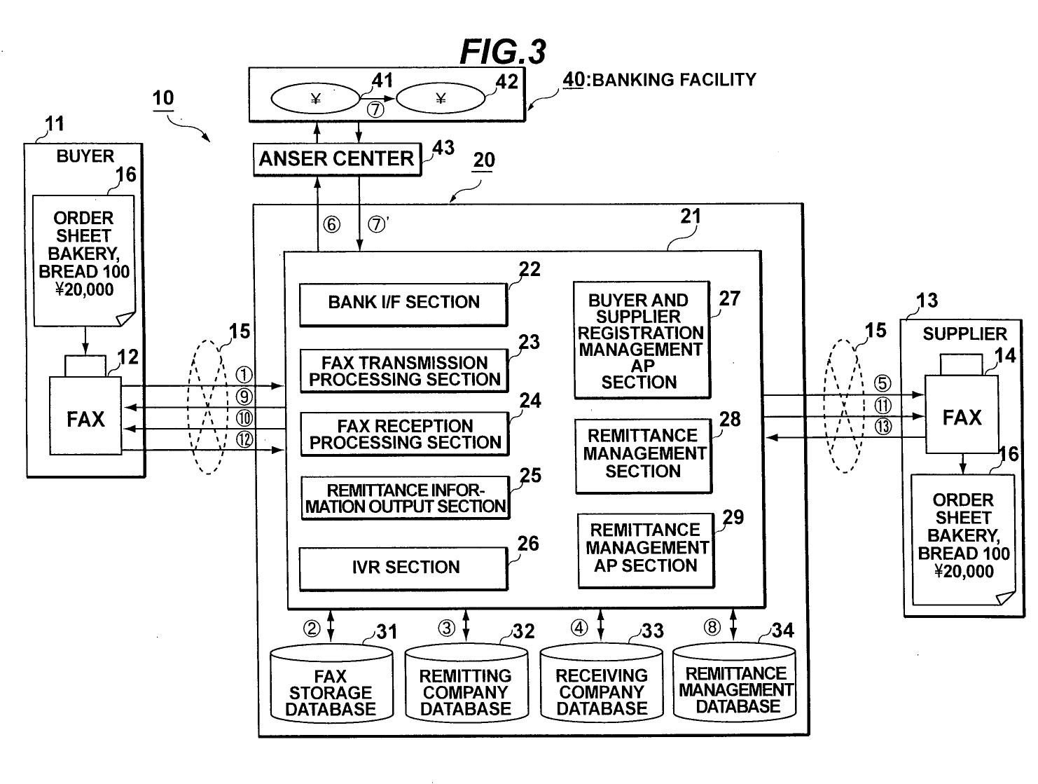

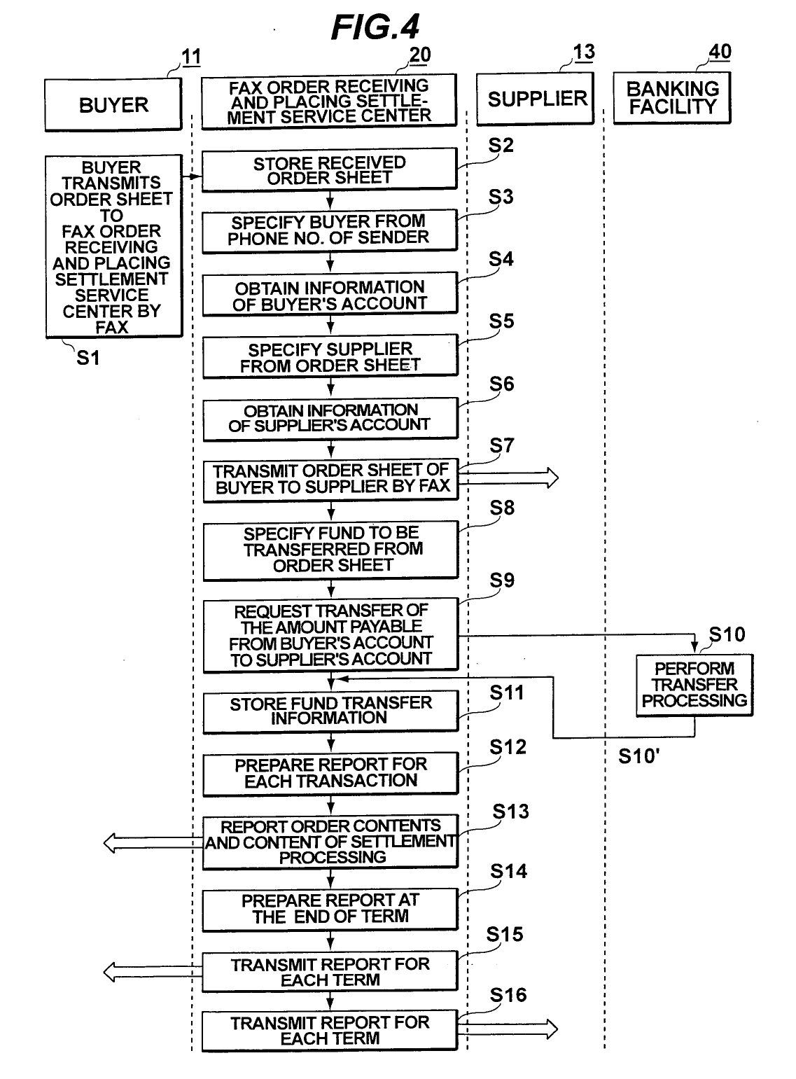

FIG. 3 illustrates the operation of the FAX order receiving and placing settlement system in the first embodiment of the present invention. FIG. 4 is a sequence diagram illustrating the operation of the FAX order receiving and placing settlement system in the first embodiment of the present invention.

At first, the buyer 11 registers in advance the information such as a phone number of the buyer's fax machine 12, an account number of the buyer's account 41 opened in the banking facility 40, the password and the like in the FAX order receiving and placing settlement service center 20. The supplier 13 from which the buyer 11 buys purchase goods also registers in advance the information such as a phone number of the supplier's fax machine 14, and an account number of the supplier's account 42 opened in the banking facility 40 in the FAX order receiving and placing settlement service center 20. In this case, explanation will be given, assuming that the buyer 11 is a bakery, and the supplier 13 is a manufacturer and wholesaler of bread.

The buyer 11 writes the items, the number and the amount of the purchase goods to be ordered in an order sheet 16 and allows the buyer's fax machine 12 to read the contents. The order sheet 16 is preferably an order sheet in which the name of the supplier 13 as an order destination, blocks for filling the item, the number and the amount of the purchase goods are printed in a predetermined format beforehand. Subsequently, the buyer 11 operates the buyer's fax machine 12 to input the phone number of the FAX order receiving and placing settlement service center 20 and transmit the fax. Then, as shown by arrow 1 in FIG. 3, the fax data on the order sheet 16 is transmitted to the FAX order receiving and placing settlement service center 20 via the public network 15. As a result, the buyer 11 can place the order for the purchase goods. The buyer 11 may select the date when the money transfer is to be executed, by filling the date in the order sheet 16.

Subsequently, in the FAX order receiving and placing settlement service center 20, when the FAX order receiving and placing settlement service server 21 receives the fax data on the order sheet 16, the FAX reception processing section 24 reads and analyzes the contents in the order sheet 16 by using an optical character reader (OCR). The fax data and the order contents in the order sheet 16 are stored in the FAX storage database 31, as shown by arrow 2 in FIG. 3. In this case, it is desired that the FAX reception processing section 24 perform error check for the contents in the order sheet 16 read and analyzed by using the OCR. After the error check, the FAX reception processing section 24 may reply to the buyer's fax machine 12 for confirmation of the contents in the order sheet 16 read and analyzed by using the OCR. The IVR section 26 may inform the buyer 11 of the reception of the fax data on the order sheet 16 by speech, when the buyer 11 selects this.

The FAX order receiving and placing settlement service server 21 adds an order number for each buyer 11 to the fax data on the order sheet 16. The fax data and the order contents in the order sheet 16 are stored in the FAX storage database 31 together with the information of the order number, the received date and time, and the like. As a result, the buyer 11 can search the order sheet 16 stored in the FAX storage database 31 by specifying the order number. Moreover, according to need, the order sheet 16 can be returned to the buyer's fax machine 12.

The FAX order receiving and placing settlement service server 21 accesses the remitting company database 32 to specify the buyer 11, as shown by arrow 3 in FIG. 3, based on the phone number of the buyer's fax machine 12, which has transmitted the fax data on the order sheet 16. The FAX order receiving and placing settlement service center 20 also obtains the information such as the account number of the buyer's account 41 opened in the banking facility 40 and the password, from the remitting company database 32. Further, the FAX order receiving and placing settlement service server 21 specifies the supplier 13 based on the name of the supplier 13 described on the order sheet 16, and as shown by arrow 4 in FIG. 3, accesses the receiving company database 33 to obtain the information such as the account number of the supplier's account 42 opened in the banking facility 40, and the phone number of the supplier's fax machine 14.

Subsequently, the FAX order receiving and placing settlement service server 21 transmits the fax data on the order sheet 16, as shown by arrow 5 in FIG. 3, to the supplier's fax machine 14 via the public network 15. The supplier's fax machine 14 issues an order sheet 16 on which the order contents are printed. As a result, the supplier 13 accepts the order for the purchase goods.

The FAX order receiving and placing settlement service server 21 specifies the price of the purchase goods from the order sheet 16, and transmits a transfer request for the amount corresponding to the price from the buyer's account 41 to the supplier's account 42, as shown by arrow 6 in FIG. 3, to the banking facility 40 via the ANSER (R) center 43. Information such as the account number and the password of the buyer's account 41, and the account number of the supplier's account 42 is also added to the transfer request. As a result, as shown by arrow 7 in FIG. 3, in the banking facility 40, the amount corresponding to the price of the purchase goods is transferred from the buyer's account 41 to the supplier's account 42.

Subsequently, the FAX order receiving and placing settlement service server 21 obtains the result of the fund transfer via the ANSER (R) center 43, as shown by arrow 7′ in FIG. 3, and accesses the remittance management database 34 to store the information relating to the movement of fund by the transfer from the buyer's account 41 to the supplier's account 42, as shown by arrow 8 in FIG. 3. The information includes the order number of the order sheet 16, the name of the buyer 11 as a remitter, the name of the supplier 13 as a receiver, the date and time (normally the date and time when the order sheet 16 is received from the buyer's fax machine 12, or the date and time when the order sheet 16 is transmitted to the supplier's fax machine 14), the transferred amount, and items such as summary. Subsequently, the FAX order receiving and placing settlement service server 21 prepares a report including the order contents in the order sheet 16 and the settlement processing result for the ordered purchase goods, and as shown by arrow 9 in FIG. 3, transmits the report to the buyer's fax machine 12 via the public network 15. The report includes the transmission status of the order sheet 16, the order contents, the name of the supplier 13, the date and time when the transaction has occurred, the transfer result, and items such as summary. The IVR section 26 may inform the buyer 11 of the contents in the report by speech. Further, a report similar to this report may be transmitted to the supplier's fax machine 14.

The FAX order receiving and placing settlement service server 21 prepares a report including the order contents and the settlement processing result for the ordered purchase goods for each of the predetermined terms, and as shown by arrows 10 and 11 in FIG. 3, transmits the report to the buyer's fax machine 12 and the supplier's fax machine 14 via the public network 15. In this case, the report is prepared and transmitted at the end of the predetermined term, for example, one month, three months or six months, for accounting and settlement of account. The report to the buyer 11 includes the name of the supplier 13, the date and time when the transaction has occurred within the term, the transfer result, and items such as summary. The report to the supplier 13 includes the name of the buyer 11, the date and time when the transaction has occurred within the term, the transfer result, and items such as summary.

When cancellation of order or change in the order contents, that is, cancellation or change of the transaction is to be made due to some circumstances, the buyer 11 can transmit an instruction relating to the cancellation or change of the transaction at any time, as shown by arrow 12 in FIG. 3, from the buyer's fax machine 12 to the FAX order receiving and placing settlement service server 21. In this case, the buyer 11 needs to specify the transaction by the order number. It is desired that the remittance management section 28 in the FAX order receiving and placing settlement service server 21 make cancellation or change of the transaction, after having obtained the approval of the supplier 13. The buyer 11 may inform the IVR section 26 of the instruction relating to the cancellation or change of the transaction by speech.

Likewise, the supplier 13 can transmit an instruction relating to the cancellation or change of the transaction at any time, as shown by arrow 13 in FIG. 3, from the supplier's fax machine 14 to the FAX order receiving and placing settlement service server 21. In this case, the supplier 13 needs to specify the transaction by the order number. It is desired that the remittance management section 28 in the FAX order receiving and placing settlement service server 21 make cancellation or change of the transaction, after having obtained the approval of the buyer 11. The supplier 13 may inform the IVR section 26 of the instruction relating to the cancellation or change of the transaction by speech.

The sequence diagram in FIG. 4 will be described below.
Step S1 The buyer 11 transmits the order sheet 16 to the FAX order receiving and placing settlement service center 20 by the buyer's fax machine 12.
Step S2 Store the received order sheet 16.
Step S3 Specify the buyer 11 based on the phone number of the buyer's fax machine 12, being a FAX sender.
Step S4 Obtain information such as the account number of the buyer's account 41 and the password.
Step S5 Specify the supplier 13 from the order sheet 16.
Step S6 Obtain information such as the account number of the supplier's account 42.
Step S7 Transmit the order sheet 16 of the buyer 11 to the supplier's fax machine 14.
Step S8 Specify the fund to be transferred from the order sheet 16.
Step S9 Request a transfer of the amount payable from the buyer's account 41 to the supplier's account 42.
Step S10 Perform transfer processing from the buyer's account 41 to the supplier's account 42 in the banking facility 40.
Step S10′ Obtain information relating to the fund transfer from the banking facility 40.
Step S11 Store the information relating to the fund transfer.
Step S12 Prepare a report for each transaction.
Step S13 Transmit the order contents and contents of the settlement processing result to the buyer's fax machine 12 and the supplier's fax machine 14 as a report.
Step S14 Prepare a report at the end of the term.
Step S15 Transmit a report for each term to the buyer's fax machine 12.
Step S16 Transmit a report for each term to the supplier's fax machine 14.

As described above, in this embodiment, when the buyer 11 transmits the order contents by fax to the FAX order receiving and placing settlement service center 20, to place an order for purchase goods, the supplier 13 receives the order contents by fax from the FAX order receiving and placing settlement service center 20, thereby to accept the order for the purchase goods. The FAX order receiving and placing settlement service center 20 requests the settlement processing of the account for the purchase goods to the banking facility 40, stores and manages the order contents and the settlement processing result for the purchase goods, and transmits a report including the order contents, the settlement processing result for the purchase goods and the like by fax to the buyer 11 and the supplier 13.

Therefore, it is not necessary for the supplier 13 to prepare a bill for the purchase goods and send it, and the amount of money for the purchase goods is automatically transferred to his/her own account. Moreover, the buyer 11 can place an order for the purchase goods, without requiring to confirm the bill, or to go through the procedure for transferring the amount of money for the purchase goods to the supplier's account 42 of the supplier 13. As a result, the labor and cost required for the buyer 11 to place an order and for the supplier 13 to receive the order can be reduced. Further, since the order contents are transferred by fax, a security problem does not occur.

A second embodiment of the present invention will be described below. Explanation for like configuration and like operation as those of the first embodiment is omitted.

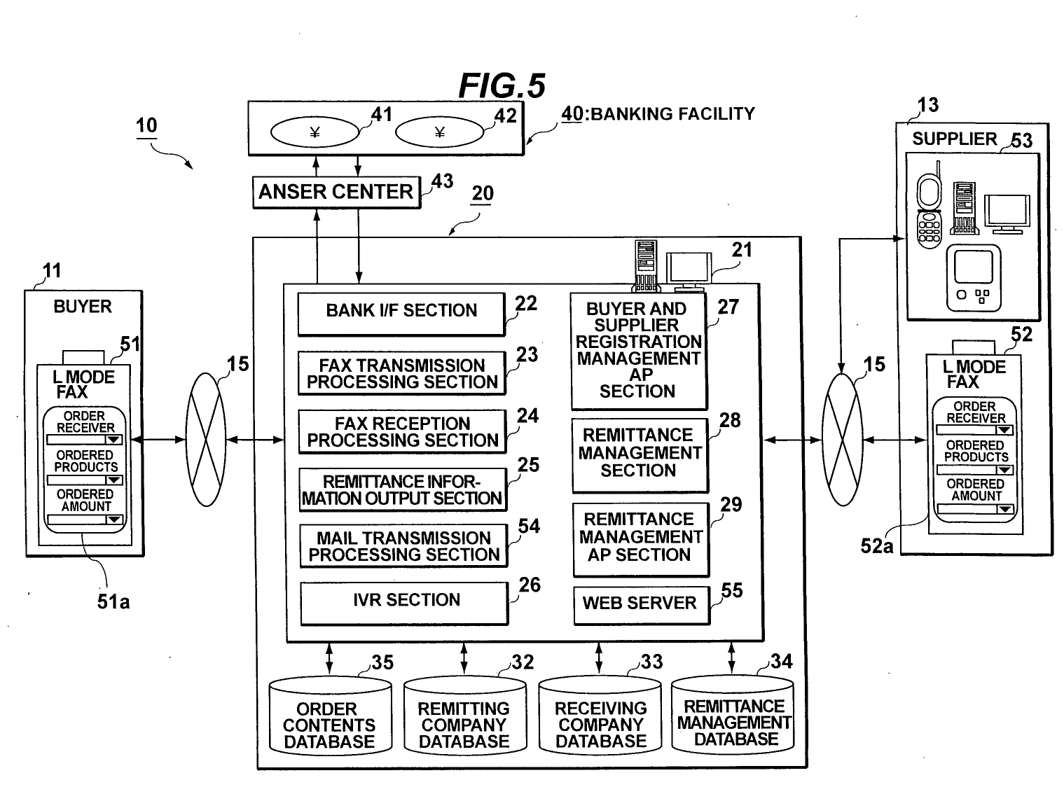

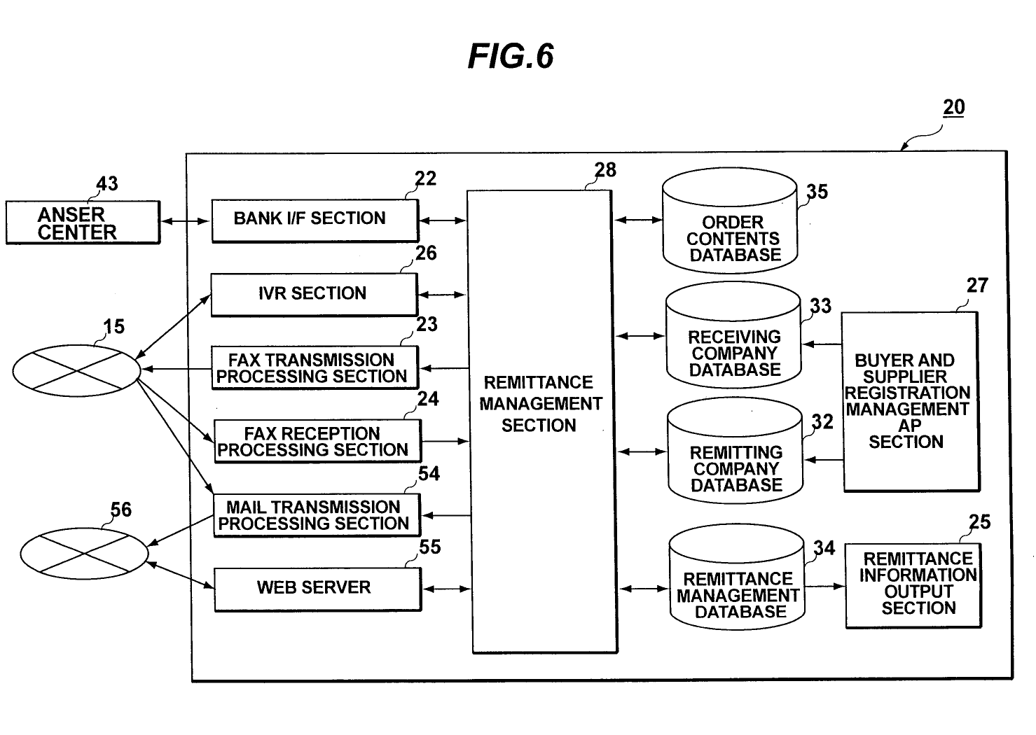

FIG. 5 is a conceptual diagram of a FAX order receiving and placing settlement system in the second embodiment of the present invention. FIG. 6 is a functional block diagram of a FAX order receiving and placing settlement service center in the second embodiment of the present invention.

In this embodiment, the buyer 11 and the supplier 13 respectively have a buyer's L mode (R) fax machine 51 and a supplier's L mode (R) fax machine 52, which are fax machines conforming to the fixed phone Internet service, that is, L mode (R), as the own fax machine. The L mode (R) stands for the fixed phone Internet service provided by phone companies such as K.K. NTT Docomo and the like, by which various services in the Internet can be received and transfer of electronic mails can be performed by using a fixed phone or a fax machine. In this case, the buyer's L mode (R) fax machine 51 and the supplier's L mode (R) fax machine 52 respectively have a display screen 51a and a display screen 52a, that can input or display the orderer (the buyer 11 or the supplier 13), the ordered products (purchase goods), the ordered amount and the like as the order contents, as shown in FIG. 5.

The public network 15 in this embodiment includes the Internet 56 as the network shown in FIG. 6. The supplier 13 comprises an information terminal 53 as a computer capable of connecting to the Internet 56, and comprising arithmetic means such as a CPU or an MPU, storage means such as a semiconductor memory or a magnetic disk, display means such as a CRT, a liquid crystal display or a light emitting diode (LED) display, and a communication interface. The information terminal 53 is for example a personal computer, and may be any kind of devices such as a personal digital assistant (PDA), an electronic note, a mobile phone, a personal handy-phone system (PHS) phone, a game machine or a digital TV, which can perform transfer of e-mails, data communications and the like by connecting to the Internet 56.

The FAX order receiving and placing settlement service server 21 in this embodiment has a mail transmission processing section 54 and a Web server 55. The mail transmission processing section 54 receives data from the remittance management section 28, prepares an electronic mail including the items to be informed to the buyer 11 or the supplier 13, and transmits the mail to the buyer's L mode (R) fax machine 51, the supplier's L mode (R) fax machine 52 or the information terminal 53 via the Internet 56. The Web server 55 receives data from the remittance management section 28, and opens a Web page that can be accessed through the Internet 56. The Web page includes a Web page displayed on the display screen 51a of the buyer's L mode (R) fax machine 51, in which the orderer, the ordered products, the ordered amount and the like can be input as the order contents. The buyer 11 and the supplier 13 can browse the Web page, or input the orderer, the ordered products, the ordered amount and the like in the Web page, by operating the buyer's L mode (R) fax machine 51, the supplier's L mode (R) fax machine 52 or the information terminal 53. In this embodiment, the FAX reception processing section 24 not only receives the order sheet transmitted by fax from the buyer's L mode (R) fax machine 51, and analyzes the contents in the order sheet and stores the contents as data, but also obtains the e-mail address included in the information of the buyer 11, and stored in the remitting company database 32.

The FAX order receiving and placing settlement service server 21 is connected to the order contents database 35 included in the FAX order receiving and placing settlement service center 20. The order contents database 35 stores the order contents, and the remittance management section 28 accesses the order contents database 35, to obtain and store the necessary information.

The operation of the FAX order receiving and placing settlement system 10 having the above configuration will be described below.

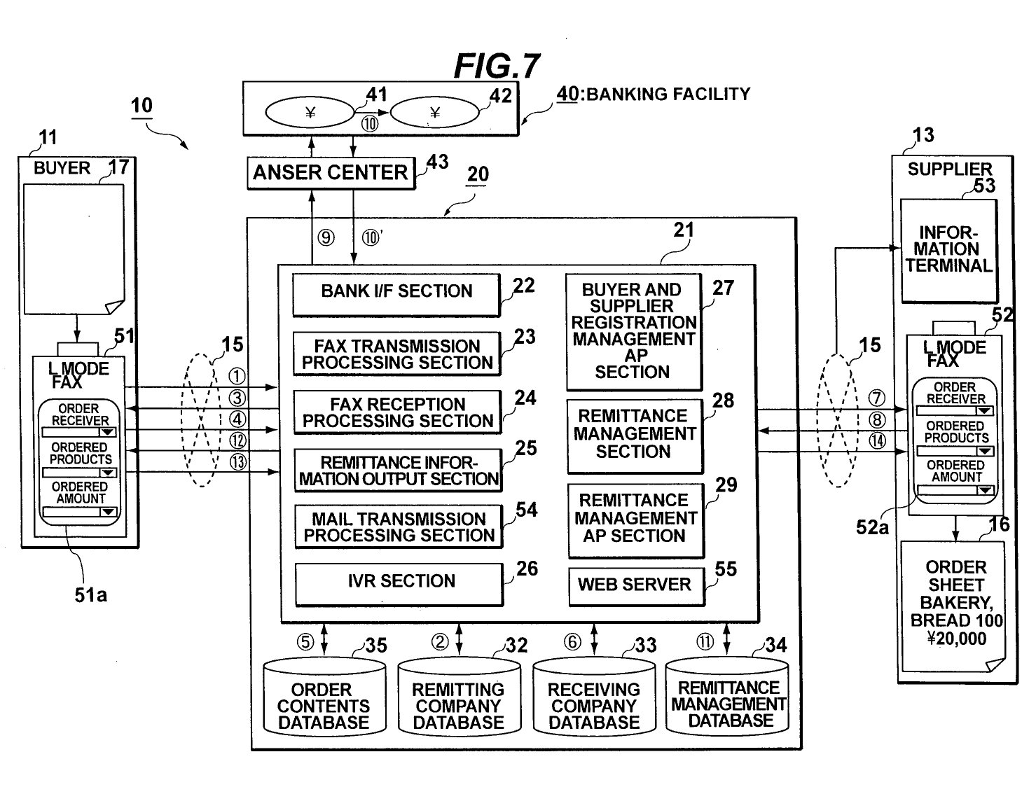

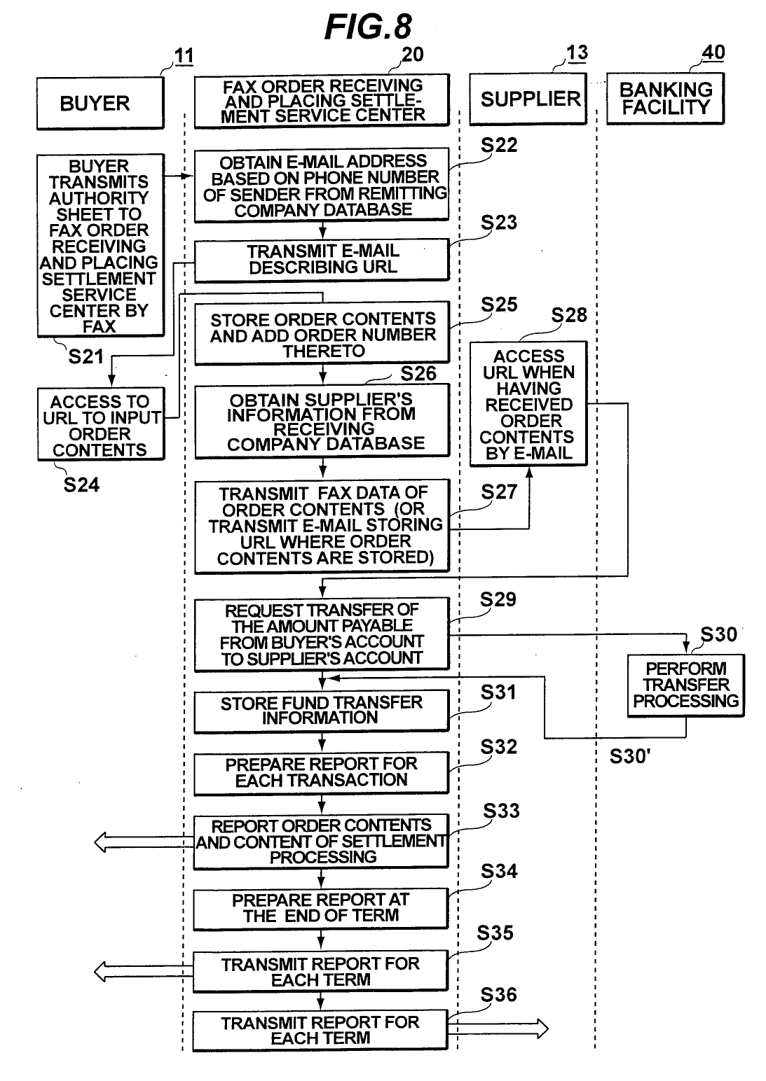

FIG. 7 illustrates the operation of the FAX order receiving and placing settlement system in the second embodiment of the present invention. FIG. 8 is a sequence diagram illustrating the operation of the FAX order receiving and placing settlement system in the second embodiment of the present invention.

In this embodiment, it is assumed that the buyer 11 and the supplier 13 have already registered their e-mail addresses as the information, in the FAX order receiving and placing settlement service center 20. At first, the buyer 11 allows the buyer's L mode (R) fax machine 51 to read an authority sheet 17, and as shown by arrow 1 in FIG. 7, to transmit it to the FAX order receiving and placing settlement service center 20. On this authority sheet 17, any items may be written.

Subsequently, when having received the fax data on the authority sheet 17, the FAX order receiving and placing settlement service server 21 in the FAX order receiving and placing settlement service center 20 accesses the remitting company database 32, as shown by arrow 2 in FIG. 7, based on the phone number of the buyer's L mode (R) fax machine 51, which has transmitted the fax data on the authority sheet 17, to obtain the e-mail address of the buyer 11. In the remitting company database 32, in addition to the e-mail address, information of the buyer 11 such as the phone number of the buyer's L mode (R) fax machine 51, the account number of the buyer's account 41 opened in the banking facility 40, the password and the like is stored beforehand.

The FAX order receiving and placing settlement service server 21 then transmits an e-mail describing the URL (Uniform Resource Locator) of the Web page, in which the orderer, the ordered products, the ordered amount and the like can be input, to the buyer 11, as shown by arrow 3 in FIG. 7. The buyer 11 then operates the buyer's L mode (R) fax machine 51, to access the URL, as shown by arrow 4 in FIG. 7, to obtain the Web page opened in the Web server 55 of the FAX order receiving and placing settlement service server 21, so that the Web page is displayed on the display screen 51a of the buyer's L mode (R) fax machine 51. The buyer 11 then inputs the order receiver, the ordered products, ordered amount and the like in the Web page. As in the first embodiment, input may be performed by writing the order receiver, the ordered products, ordered amount and the like in the order sheet 16 as the order contents, and allowing the buyer's L mode (R) fax machine 51 to read the contents. Subsequently, the buyer 11 operates the buyer's L mode (R) fax machine 51 to send back the Web page, in which the order receiver, the ordered products, ordered amount and the like are input, to the FAX order receiving and placing settlement service server 21. As a result, the buyer 11 places an order for the purchase goods. The buyer 11 may select the date and time when the money transfer is to be executed, by writing the date and time in the order sheet 16.

The FAX order receiving and placing settlement service server 21 stores the order contents in the order contents database 35, as shown by arrow 5 in FIG. 7. The FAX order receiving and placing settlement service server 21 also adds an order number to each of the received orders. The order contents are stored in the order contents database 35, together with the order number, the received date and time, and information such as summary. As a result, the buyer 11 can search the order stored in the order contents database 35 by specifying the order number. Moreover, according to need, the order contents can be returned to the buyer's L mode (R) fax machine 51 by fax or by an e-mal. Further, the FAX order receiving and placing settlement service server 21 can insert the order contents in the Web page opened in the Web server 55.

The FAX order receiving and placing settlement service server 21 then specifies the supplier 13 based on the order receiver, and as shown by arrow 6 in FIG. 7, accesses the receiving company database 33 to obtain the information such as the account number of the supplier's account 42 opened in the banking facility 40, the phone number of the supplier's L mode (R) fax machine 52, and the e-mail address.

Subsequently, the FAX order receiving and placing settlement service server 21 transmits the fax data of the order contents, as shown by arrow 7 in FIG. 7, to the supplier's L mode (R) fax machine 52 via the public network 15. The supplier's L mode (R) fax machine 52 issues an order sheet 16 on which the order contents are printed. As a result, the supplier 13 accepts the order for the purchase goods.

The FAX order receiving and placing settlement service server 21 may transmit an e-mail describing the URL of the Web page, in which the order contents are written, to the supplier's L mode (R) fax machine 52 or the information terminal 53. In this case, the supplier 13 operates the supplier's L mode (R) fax machine 52 or the information terminal 53, to access the URL, as shown by arrow 8 in FIG. 7, to obtain the Web page opened in the Web server 55 in the FAX order receiving and placing settlement service server 21, so that the Web page is displayed on the display screen 52a of the supplier's L mode (R) fax machine 52 or display means of the information terminal 53. In this case, the supplier 13 browses the display screen 52a of the supplier's L mode (R) fax machine 52 or the information terminal 53 to accept the order for the purchase goods. The supplier's L mode (R) fax machine 52 may issue the order sheet 16 on which the order contents displayed on the display screen 52a are printed.

The FAX order receiving and placing settlement service server 21 transmits a transfer request for the amount corresponding to the price of the purchase goods from the buyer's account 41 to the supplier's account 42, as shown by arrow 9 in FIG. 7, to the banking facility 40 via the ANSER (R) center 43. Information such as the account number and the password of the buyer's account 41, and the account number of the supplier's account 42 is also added to the transfer request. As a result, as shown by arrow 10 in FIG. 7, in the banking facility 40, the amount corresponding to the price of the purchase goods is transferred from the buyer's account 41 to the supplier's account 42.

Subsequently, the FAX order receiving and placing settlement service server 21 obtains the result of the fund transfer via the ANSER (R) center 43, as shown by arrow 10′ in FIG. 7, and accesses the remittance management database 34 to store the information relating to the movement of fund by the transfer from the buyer's account 41 to the supplier's account 42, as shown by arrow 11 in FIG. 7. The information includes the order number of the order sheet 16, the name of the buyer 11 as a remitter, the name of the supplier 13 as a receiver, the date and time when the transaction has occurred, the transferred amount, and items such as summary.

Subsequently, the FAX order receiving and placing settlement service server 21 prepares a report including the order contents and the settlement processing result for the ordered purchase goods, and as shown by arrow 12 in FIG. 7, transmits the report to the buyer's L mode (R) fax machine 51 via the public network 15. The report includes the transmission status of the order sheet 16, the order contents, the name of the supplier 13, the date and time when the transaction has occurred, the transfer result, and items such as summary. A report similar to this report may be transmitted to the supplier's L mode (R) fax machine 52. The IVR section 26 may inform the buyer 11 of the contents in the report by speech, or the mail transmission processing section 54 may transmit an e-mail describing the report to the buyer's L mode (R) fax machine 51.

The FAX order receiving and placing settlement service server 21 prepares a report including the order contents and the settlement processing result for the ordered purchase goods for each of the predetermined terms, and as shown by arrows 13 and 14 in FIG. 7, transmits the report to the buyer's L mode (R) fax machine 51 and the supplier's L mode (R) fax machine 52 via the public network 15. In this case, the report is prepared and transmitted at each end of the predetermined terms, for example, one month, three months or six months, for accounting and settlement of account. The report to the buyer 11 includes the name of the supplier 13, the date and time when the transaction has occurred within the term, the transfer result, and items such as summary. The report to the supplier 13 includes the name of the buyer 11, the date and time when the transaction has occurred within the term, the transfer result, and items such as summary. The FAX order receiving and placing settlement service server 21 may transmit an e-mail describing the report to the buyer's L mode (R) fax machine 51 and the supplier's L mode (R) fax machine 52.

The FAX order receiving and placing settlement service server 21 may insert the report in the Web page opened in the Web server 55, and transmit the URL of the Web page to the buyer's L mode (R) fax machine and the supplier's L mode (R) fax machine 52, or the information terminal 53. In this case, the buyer 11 and the supplier 13 operates the buyer's L mode (R) fax machine and the supplier's L mode (R) fax machine 52, or the information terminal 53, to access the URL to obtain the Web page opened in the Web server 55 in the FAX order receiving and placing settlement service server 21.

When cancellation of order or change in the order contents, that is, cancellation or change of the transaction is to be made due to some circumstances, the buyer 11 can transmit an instruction relating to the cancellation or change of the transaction at any time, from the buyer's L mode (R) fax machine 51 to the FAX order receiving and placing settlement service server 21. In this case, the buyer 11 needs to specify the transaction by the order number. It is desired that the remittance management section 28 in the FAX order receiving and placing settlement service server 21 make cancellation or change of the transaction, after having obtained the approval of the supplier 13. The buyer 11 may inform the IVR section 26 of the instruction relating to the cancellation or change of the transaction by speech.

Likewise, the supplier 13 can transmit an instruction relating to cancellation or change of the transaction at any time, from the supplier's L mode (R) fax machine 52 to the FAX order receiving and placing settlement service server 21. In this case, the supplier 13 needs to specify the transaction by the order number. It is desired that the remittance management section 28 in the FAX order receiving and placing settlement service server 21 make cancellation or change of the transaction, after having obtained the approval of the buyer 11. The supplier 13 may inform the IVR section 26 of the instruction relating to the cancellation or change of the transaction by speech.

The sequence diagram will be described below.
Step S21 The buyer 11 transmits the authority sheet 17 to the FAX order receiving and placing settlement service center 20 by the buyer's L mode (R) fax machine 51.
Step S22 Specify the e-mail address based on the phone number of the buyer's L mode (R) fax machine 51, being the sender, from the remitting company database 32.
Step S23 Transmit an e-mail describing the URL of the Web page for inputting the order information to the buyer 11.
Step S24 The buyer 11 accesses the URL to allow the Web page to be displayed and input the order contents.
Step S25 Store the order contents in the order contents database 35, and add an order number to each order.
Step S26 Obtain information such as the account number of the supplier's account 42, the phone number of the supplier's L mode (R) fax machine 52, the e-mail address and the like from the receiving company database 33.
Step S27 Transmit the fax data of the order contents. Alternatively, transmit an e-mail describing the URL in which the order contents are stored.
Step S28 When having received the e-mail, access the URL for confirmation of the order information.
Step S29 Request a transfer of the amount payable from the buyer's account 41 to the supplier's account 42.
Step S30 The banking facility 40 performs transfer processing from the buyer's account 41 to the supplier's account 42.
Step S30′ Obtain information relating to the fund transfer from the banking-facility 40.
Step S31 Store information relating to the fund transfer.
Step S32 Prepare a report for each transaction.
Step S33 Transmit and report the order contents and the content of the settlement processing result to the buyer's L mode (R) fax machine 51.
Step S34 Prepare a report at the end of the term.
Step S35 Transmit a report for each term to the buyer's L mode (R) fax machine 51.
Step S36 Transmit a report for each term to the supplier's L mode (R) fax machine 52.

As described above, in this embodiment, the buyer 11 and the supplier 13 respectively use the buyer's L mode (R) fax machine 51 and the supplier's L mode (R) fax machine 52, which are fax machines adapted for the L mode (R). Therefore, reception and placement of order for the purchase goods can be performed by fax or by using an e-mail or a Web page. As a result, the buyer 11 and the supplier 13 can receive or place an order for the purchase goods, by selecting the most convenient means.

In the first and the second embodiments, explanation has been given for a case where settlement processing of the account for the purchase goods is performed by transferring money from the buyer's account 41 to the supplier's account 42 opened in the banking facility 40. However, the settlement processing may be any type of settlement processing, such as credit settlement processing using a credit card or the like, settlement processing using an electronic money, or settlement processing using a net settlement system in which a settlement service organization executes the settlement processing as a proxy.

The present invention is not limited to the above embodiments, and can be modified variously based on the purport of the present invention, and these modifications are not excluded from the scope of the present invention.

### INDUSTRIAL APPLICABILITY

As described above in detail, according to the present invention, when reception and placement of an order for purchase goods are performed by using facsimile, settlement of account is automatically performed. Therefore, it is not necessary for the supplier to prepare and send a bill, or go to the buyer directly. The buyer is not required to confirm the bill or go through the procedure for transferring money to the supplier's account. The supplier is not required to confirm the payment. As a result, reception and placement of orders for the purchase goods can be made easily, the cost thereof can be reduced, and security in receiving and placing orders for the purchase goods can be improved.

1. A FAX order receiving and placing settlement system comprising:
(a) a fax machine of a buyer who places an order for purchase goods or services;
(b) a fax machine of a supplier who receives the order for purchase goods or services;
(c) a settlement organization which performs settlement processing of the account for the purchase goods or services; and
(d) a FAX order receiving and placing settlement service center connected to the buyer's fax machine, the supplier's fax machine and the settlement organization so as to be able to communicate with one another,
(e) wherein the FAX order receiving and placing settlement service center transmits order information to the supplier's fax machine based on order information received from the buyer's fax machine, requests the settlement organization to perform settlement processing of the account for the purchase goods or services, and returns a report including the result of the settlement processing to the buyer's fax machine and the supplier's fax machine.

2. The FAX order receiving and placing settlement system according to claim 1, wherein the buyer's fax machine or the supplier's fax machine conforms to the fixed phone Internet service.

3. The FAX order receiving and placing settlement system according to claim 1, wherein the FAX order receiving and placing settlement service center comprises databases for storing order reception information, the order placement information, and settlement processing results, and transmits a report including the settlement processing results within a predetermined term, to the buyer's fax machine or the supplier's fax machine.

4. The FAX order receiving and placing settlement system according to claim 1, wherein the FAX order receiving and placing settlement service center comprises a buyer and supplier registration management AP section, for registering in advance and managing information of a buyer and a supplier who has dealings with the buyer.

5. The FAX order receiving and placing settlement system according to claim 1, wherein the FAX order receiving and placing settlement service center comprises a FAX reception processing section and a FAX transmission processing section, for analyzing fax data in a received order sheet by using an OCR function, and returning the fax data to the buyer's fax machine for confirmation.

6. The FAX order receiving and placing settlement system according to claim 1, wherein the FAX order receiving and placing settlement service center comprises a remittance management section, and when the buyer transmits an instruction relating to cancellation or change of order placement from the fax machine or by phone, the FAX order receiving and placing settlement service center cancels or changes the transaction.

7. The FAX order receiving and placing settlement system according to of claim 1, wherein the FAX order receiving and placing settlement service center comprises a remittance management section, and when the supplier transmits an instruction relating to cancellation or change of order placement from the fax machine or by phone, the FAX order receiving and placing settlement service center cancels or changes the transaction.

8. The FAX order receiving and placing settlement system according to claim 1, wherein, in a case where the buyer's fax machine conforms to the fixed phone Internet service, when the buyer transmits fax data on an authority sheet to the FAX order receiving and placing settlement service center, the FAX order receiving and placing settlement service center obtains an e-mail address of the buyer based on the received phone number, and performs authentication of the buyer by transmitting an e-mail to the buyer.

9. The FAX order receiving and placing settlement system according to claim 1, wherein, in a case where the buyer's fax machine conforms to the fixed phone Internet service, and when the buyer transmits fax data on an authority sheet to the FAX order receiving and placing settlement service center, the FAX order receiving and placing settlement service center obtains an e-mail address of the buyer based on the received phone number, and transmits an e-mail describing the URL of a Web page, in which an orderer, an ordered products, an ordered amount and the like can be input, to the buyer, and the buyer places an order by inputting the data into the Web page.

10. A FAX order receiving and placing settlement service center comprising:
(a) a reception processing section which receives order information for purchase goods or services from a buyer's fax machine, analyzes and stores the information in database;
(b) a transmission processing section which transmits the order information for purchase goods or services to a supplier's fax machine; and
(c) a settlement organization communication interface section communicating with a settlement organization which performs settlement processing of the account for the purchase goods or services,
(d) wherein the FAX order receiving and placing settlement service center transmits the order information to the supplier's fax machine based on the order information, requests the settlement organization to perform settlement processing of the account for the purchase goods or services, and returns a report including the settlement processing result to the buyer's fax machine and the supplier's fax machine.

11. The FAX order receiving and placing settlement service center according to claim 10, comprising a remittance management section which manages the movement of funds based on the settlement processing, and remittance management database for storing the history of the movement of funds.

12. The FAX order receiving and placing settlement service center according to claim 10, which transmits a report including the result of the settlement processing within a predetermined term to the buyer's fax machine or the supplier's fax machine.

13. A FAX order receiving and placing settlement service program which causes a computer to function as:
(a) in order to receive or place an order for purchase goods or services and settle the account,
(b) a reception processing section which receives order information for purchase goods or services from a buyer's fax machine;
(c) a transmission processing section which transmits the order information for purchase goods or services to a supplier's fax machine; and
(d) a settlement organization communication interface section communicating with a settlement organization which performs settlement processing of the account for the purchase goods or services, in order to receive or place an order for purchase goods or services and settle the account,
(e) so that the order information is transmitted to the supplier's fax machine based on the order information, settlement processing of the account for the purchase goods or services is requested to the settlement organization, and a report including the settlement processing result is returned to the buyer's fax machine and the supplier's fax machine.

14. A FAX order receiving and placing settlement method, wherein,
(a) when order information is received from a fax machine of a buyer who places an order for purchase goods or services,
(b) the order information is transmitted to a fax machine of a supplier who receives the order for purchase goods or services,
(c) settlement processing of the account for the purchase goods or services is requested to a settlement organization, and
(d) a report including the settlement processing result is returned to the buyer's fax machine or the supplier's fax machine.

15. The FAX order receiving and placing settlement system according to claim 2, wherein the FAX order receiving and placing settlement service center comprises databases for storing order reception information, the order placement information, and settlement processing results, and transmits a report including the settlement processing results within a predetermined term, to the buyer's fax machine or the supplier's fax machine.

16. The FAX order receiving and placing settlement system according to claim 2, wherein the FAX order receiving and placing settlement service center comprises a buyer and supplier registration management AP section, for registering in advance and managing information of a buyer and a supplier who has dealings with the buyer.

17. The FAX order receiving and placing settlement system according to claim 2, wherein the FAX order receiving and placing settlement service center comprises a FAX reception processing section and a FAX transmission processing section, for analyzing fax data in a received order sheet by using an OCR function, and returning the fax data to the buyer's fax machine for confirmation.

18. The FAX order receiving and placing settlement system according to claim 2, wherein the FAX order receiving and placing settlement service center comprises a remittance management section, and when the buyer transmits an instruction relating to cancellation or change of order placement from the fax machine or by phone, the FAX order receiving and placing settlement service center cancels or changes the transaction.

19. The FAX order receiving and placing settlement system according to of claim 2, wherein the FAX order receiving and placing settlement service center comprises a remittance management section, and when the supplier transmits an instruction relating to cancellation or change of order placement from the fax machine or by phone, the FAX order receiving and placing settlement service center cancels or changes the transaction.

20. The FAX order receiving and placing settlement system according to claim 2, wherein, in a case where the buyer's fax machine conforms to the fixed phone Internet service, when the buyer transmits fax data on an authority sheet to the FAX order receiving and placing settlement service center, the FAX order receiving and placing settlement service center obtains an e-mail address of the buyer based on the received phone number, and performs authentication of the buyer by transmitting an e-mail to the buyer.
